(19) United States
(12) Patent Application Publication
(10) Pub. No.: US 2024/0213498 A1
(43) Pub. Date: Jun. 27, 2024

(54) CATALYST

(71) Applicant: TOYOTA JIDOSHA KABUSHIKI KAISHA, Toyota-shi (JP)

(72) Inventor: Nobuaki MIZUTANI, Toyota-shi (JP)

(21) Appl. No.: 18/539,655

(22) Filed: Dec. 14, 2023

(30) Foreign Application Priority Data
Dec. 21, 2022 (JP) 2022-203860

(51) Int. Cl. H01M 4/90

(52) U.S. Cl. CPC H01M 4/9083

(57) ABSTRACT

To provide a catalyst, which is configured to suppress a decrease in voids in a catalyst layer. A catalyst for fuel cells, wherein the catalyst comprises a metal catalyst and a carbon support; wherein the carbon support supports the metal catalyst; wherein the carbon support is carbon support particles; wherein a specific surface area of the carbon support particles is 800 m²/g or more and 1200 m²/g or less; wherein a particle size of the carbon support particles is 200 nm or more and 400 nm or less; and wherein a bulk density of the carbon support particles is 0.02 g/ml or more and 0.07 g/ml or less.

### TECHNICAL FIELD

The disclosure relates to a catalyst for fuel cells.

### BACKGROUND

Various studies have been made on fuel cells (FC). Patent Literature 1 discloses support particles for fuel cell catalysts, the particles having a diameter of from 100 nm to 300 nm, a fine pore size of from 3 nm to 6 nm, and a specific surface area of 800 m²/g or more.
Patent Literature 1: Japanese Patent Application Laid-Open (JP-A) No. 2019-169317

When the lean rate of the catalyst layer increases after long-term use of the fuel cell, the voids in the catalyst layer decrease and the gas diffusion resistance of the fuel cell increases.

### SUMMARY

The disclosure was achieved in light of the above circumstances. An object of the disclosure is to provide a catalyst for fuel cells, which is configured to suppress a decrease in voids in the catalyst layer.

The catalyst for fuel cells according to the present disclosure is a catalyst for fuel cells,
wherein the catalyst comprises a metal catalyst and a carbon support;
wherein the carbon support supports the metal catalyst;
wherein the carbon support is carbon support particles;
wherein a specific surface area of the carbon support particles is 800 m²/g or more and 1200 m²/g or less;
wherein a particle size of the carbon support particles is 200 nm or more and 400 nm or less; and
wherein a bulk density of the carbon support particles is 0.02 g/ml or more and 0.07 g/ml or less.

In the catalyst of the present disclosure, the particle size of the carbon support particles may be 300 nm or more and 400 nm or less.

In the catalyst of the present disclosure, the bulk density of the carbon support particles may be 0.05 g/ml or more and 0.07 g/ml or less.

The present disclosure can provide the catalyst for fuel cells, which is configured to suppress a decrease in voids in the catalyst layer.

### BRIEF DESCRIPTION OF THE DRAWINGS

In the accompanying drawings,

FIG. 1 shows a graph showing the relationship between the specific surface area of the carbon support particles and the lean ratio of the catalyst layer in Comparative Examples 1, 3, 5, and 6;

FIG. 2 shows a graph showing the relationship between the specific surface area of the carbon support particles and the lean ratio of the catalyst layer in Examples 2, 3 and 5 and Comparative Example 6;

FIG. 3 shows a graph showing the relationship between the particle size of the carbon support particles and the lean ratio of the catalyst layer in Examples 3 and 4 and Comparative Examples 3 and 4;

FIG. 4 shows a graph showing the relationship between the bulk density of the carbon support particles and the lean ratio of the catalyst layer in Examples 3 and 4 and Comparative Examples 3 and 4;

FIG. 5 shows a graph showing the relationship between the specific surface area of the carbon support particles and the voltage of the fuel cell when the power generation performance of the fuel cell before and after a durability test was evaluated in a predetermined condition in Examples 2, 3 and 5 and Comparative Example 6; and

FIG. 6 shows a graph showing the relationship between the particle size of the carbon support particles and the gas diffusion resistance of the fuel cell before and after the durability test in Examples 3 and 4 and Comparative Examples 3 and 4.

### DETAILED DESCRIPTION

Hereinafter, the embodiments of the present disclosure will be described in detail. Matters that are required to implement the present disclosure (such as common catalyst for fuel cells structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In the Specification, “-” used to indicate a numerical range, is used to mean that the range includes the numerical values described before and after “-” as the lower and the upper limit values.

Also in the Specification, the upper and lower limit values of the numerical range may be a desired combination.

The catalyst for fuel cells of the present disclosure is a catalyst for fuel cells, wherein the catalyst comprises a metal catalyst and a carbon support;
wherein the carbon support supports the metal catalyst;
wherein the carbon support is carbon support particles;
wherein a specific surface area of the carbon support particles is 800 m²/g or more and 1200 m²/g or less;
wherein a particle size of the carbon support particles is 200 nm or more and 400 nm or less; and
wherein a bulk density of the carbon support particles is 0.02 g/ml or more and 0.07 g/ml or less.

The specific surface area (SSA), particle size, and bulk density of the carbon support particles are controlled within predetermined limits. As a result, it is possible to suppress a decrease in the air gap of the catalyst layer, and it is possible to achieve both the initial power generation performance and the durability performance of the fuel cell.

The catalyst of the present disclosure includes a metal catalyst and a carbon support.

Examples of the metal catalyst include metals such as platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and two or more of these metals may be used. The metal may be an oxide, a nitride, a sulfide, a phosphide, or the like.

The metal catalyst may be platinum, a platinum alloy, or the like.

Metals other than platinum included in the platinum alloy include metals such as ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and may contain two or more of these metals. The metal catalyst may be platinum, a platinum-cobalt alloy, a platinum-nickel alloy, or the like.

The metal catalyst may be metal catalyst particles that are particulate in shape.

The particle size of the metal-catalyst particles is not particularly limited, but may be 1 nm or more and 100 nm or less.

The metal catalyst is supported on a carbon support.

The particle size of the metal-catalyst particles is a volume-based median diameter (D50) measured by laser diffractometry and scattering-type particle size distribution measurement. In the present disclosure, the median diameter (D50) is a diameter (volume-average diameter) in which the cumulative volume of the particles is half (50%) of the total volume when the particles are arranged in ascending order of the particle diameter.

The carbon support is at least one carbon support particle that is particulate in shape.

The carbon support may be a primary particle or a secondary particle.

The carbon support carries a metal catalyst.

A method of supporting the metal catalyst on the carbon support is not particularly limited, and a conventionally known method can be appropriately employed.

The carbon support may be acetylene black, Ketjen black, channel black, roller black, disk black, oil furnace black, gas furnace black, lamp black, thermal black, activated carbon, graphite, glassy carbon, graphene, carbon fiber, carbon nanotube, carbon nitride, sulfurized carbon, and phosphated carbon, or a mixture containing at least two of these.

The specific surface area of the carbon support particles is 800 m²/g or more and 1200 m²/g or less.

The specific surface area is BET specific surface area measured by BET method.

The particle size of the carbon support particles is 200 nm or more and 400 nm or less. The particle size of the carbon support particles may be 300 nm or more and 400 nm or less.

In the carbon support particles of the present disclosure, the equivalent circle diameter of 100 to 1000 particles may be calculated as the particle diameter by an electron microscope, and the average particle diameter thereof may be set as the particle diameter of the particles. The particle size of the carbon support particles can be measured by 3D-TEM or the like.

The bulk density of the carbon support particles is 0.02 g/ml or more and 0.07 g/ml or less. The bulk density of the carbon support particles may be greater than or equal to 0.04 g/ml or greater than or equal to 0.05 g/ml.

The bulk density is measured in accordance with JIS K1469: 2003 standard.

The catalyst of the present disclosure is used for fuel cells, and specifically, is used for a catalyst layer of a fuel cell.

The catalyst layer comprises a catalyst of the present disclosure.

The catalyst layer may be a cathode catalyst layer, an anode catalyst layer, or both a cathode catalyst layer and an anode catalyst layer.

### [Production of Catalyst Layer]

The catalyst layer of the present disclosure is formed by applying a catalyst ink to a substrate. After the catalyst ink is applied onto the substrate, the solvent in the catalyst ink may be removed. The solvent may be removed by warming and drying the catalyst ink after coating on the substrate.

The catalyst ink may be obtained by dispersing a raw material mixture containing a metal catalyst, a carbon support, an ionomer, and a solvent. The method of dispersing the raw material mixture may be, for example, a method using a ball mill such as an ultrasonic homogenizer, a jet mill, or a bead mill, a high shear, a fill mix, or the like. The dispersion conditions such as the dispersion time are not particularly limited, and can be appropriately set.

The ionomer may be, for example, a fluorine-based resin such as a perfluorocarbon sulfonic acid polymer or a Nafion solution (manufactured by Du Pont Corporation).

The amount of the ionomer contained in the catalyst ink may be 1% by mass or more and less than 10% by mass.

The solvent may be water, an organic solvent, a mixed solvent of water and an organic solvent, or the like.

Examples of the organic solvents include methanol, diacetone alcohol, ethanol, 1-propanol, 2-propanol, tert-butyl alcohol, ethylene glycol, and propylene glycol.

When a mixed solvent of water and an organic solvent is used, the content of the organic solvent in the mixed solvent can be arbitrarily selected depending on the purpose.

Examples of the substrate include polytetrafluoroethylene (PTFE) and the like.

Examples of the coating method include a die coating method, a spin coating method, a screen printing method, a doctor blade method, a squeegee method, a spray coating method, and an applicator method. The heating rate and the heating time of the catalyst ink at the time of coating can be appropriately set depending on the solvent species and the like. Further, the removal rate of the solvent may be increased by degassing simultaneously with warming.

The coating thickness of the catalyst layer may be 2.0 to 30 μm or 6.0 to 12.4 μm.

Void ratio of the catalyst layer may be 7 to 41% or 12 to 41%.

The fuel cell may have only one single cell, or may be a fuel cell stack in which a plurality of single cells are stacked.

In the present disclosure, both the single cell and the fuel cell stack may be referred to as a fuel cell.

The number of stacked single cells is not particularly limited, and may be, for example, 2 to several hundred.

The single cell includes at least a membrane electrode gas diffusion layer assembly.

The membrane electrode gas diffusion layer assembly includes an anode-side gas diffusion layer, an anode catalyst layer, an electrolyte membrane, a cathode catalyst layer, and a cathode-side gas diffusion layer in this order.

The cathode (oxidant electrode) includes a cathode catalyst layer and a cathode-side gas diffusion layer.

The anode (fuel electrode) includes an anode catalyst layer and an anode-side gas diffusion layer.

The cathode catalyst layer and the anode catalyst layer are collectively referred to as a catalyst layer.

The cathode-side gas diffusion layer and the anode-side gas diffusion layer are collectively referred to as a gas diffusion layer.

The gas diffusion layer may be a conductive member or the like having gas permeability.

Examples of the conductive member include a carbon porous body such as carbon cloth and carbon paper, and a metal porous body such as a metal mesh and a metal foam.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The single cell may include two separators that sandwich both surfaces of the membrane electrode gas diffusion layer assembly as needed. The two separators are one anode-side separator and the other cathode-side separator. In the present disclosure, the anode-side separator and the cathode-side separator are collectively referred to as a separator.

The separator may have holes constituting a manifold such as a supply hole and a discharge hole for allowing a fluid such as a reaction gas and a cooling medium to flow in the stacking direction of the single cells.

As the cooling medium, for example, a mixed solution of ethylene glycol and water can be used in order to prevent freezing at low temperatures. As the cooling medium, air for cooling can be used.

Examples of the supply hole include a fuel gas supply hole, an oxidant gas supply hole, and a cooling medium supply hole.

Examples of the discharge hole include a fuel gas discharge hole, an oxidant gas discharge hole, and a cooling medium discharge hole.

The separator may have a reaction gas flow path on a surface in contact with the gas diffusion layer. In addition, the separator may have a cooling medium flow path for keeping the temperature of the fuel cell constant on a surface opposite to the surface in contact with the gas diffusion layer.

The separator may be a gas impermeable conductive member or the like. The conductive member may be, for example, dense carbon obtained by compressing carbon to make it gas impermeable, and press-formed metal (for example, iron, aluminum, stainless steel, and the like). In addition, the separator may have a current collecting function.

In the present disclosure, the fuel gas and the oxidizing gas are collectively referred to as a reaction gas. The reaction gas supplied to the anode is a fuel gas, and the reaction gas supplied to the cathode is an oxidant gas. The fuel gas is a gas mainly containing hydrogen, and may be hydrogen. The oxidizing gas is a gas containing oxygen, and may be air or the like.

The fuel cell stack may include a manifold such as an inlet manifold in which the supply holes are in communication with each other and an outlet manifold in which the discharge holes are in communication.

Inlet manifolds include fuel gas inlet manifolds, oxidant gas inlet manifolds, coolant inlet manifolds, and the like.

The outlet manifold may include a fuel gas outlet manifold, an oxidant gas outlet manifold, a coolant outlet manifold, and the like.

The fuel cell stack may be configured such that both ends thereof are sandwiched between a pair of end plates. As the end plate, for example, a metal such as stainless steel can be used. As the end plate, for example, an engineering plastic containing a thermosetting resin such as phenolic resin, epoxy glass, and polyester glass can be used.

### Examples

### Examples 1 to 6, Comparative Examples 1 to 6

Carbon support particles having a specific surface area, a particle size, and a bulk density shown in Table 1 were prepared. Then, a catalyst in which a metal catalyst was supported on the carbon support was prepared. Then, a fuel cell using the catalyst layer containing the catalyst was prepared.

### <Evaluation of Thinness Rate of Catalyst Layer>

The fuel cell was subjected to a durability test of a predetermined number of cycles in a predetermined potential range.

The thickness of the initial catalyst layer before the durability test and the thickness of the catalyst layer after the durability test were measured. From these, the lean rate of the catalyst layer after the durability test was calculated. The results obtained are shown in Table 1.

As for the thickness of the catalyst layer, the average thickness of the catalyst layer was calculated from the scanning electron microscope (SEM) images of the catalyst layer, and the average thickness of the catalyst layer was defined as the thickness of the catalyst layer.

The percentage lean of the catalyst layer was calculated from the following formula.

Lean rate of the catalyst layer=(1−catalyst layer thickness after durability/initial catalyst layer thickness)×100

### <Catalyst-Layer Void Ratio Assessment>

Void ratio of the catalyst layer in the early stage prior to the durability test and void ratio of the catalyst layer after the durability test were also measured. The results obtained are shown in Table 1.

### <Evaluation of Power Generation Performance of Fuel Cell>

The initial fuel cell before the durability test and the fuel cell after the durability test were evaluated for power generation performance under the following conditions. 100% RH and 2 A/cm² were used to generate electricity and to measure the potential of the cell. The results obtained are shown in Table 2.

In addition, the gas diffusion resistance of the initial fuel cell before the durability test and the gas diffusion resistance of the fuel cell after the durability test were measured. The results obtained are shown in Table 2.

TABLE 1

| | | | | Early | After | | Early | After |
|---|---|---|---|---|---|---|---|---|
| | | Carbon | Carbon | stage | durability | Catalyst | stage | durability |
| | Carbon | support | support | Catalyst | Catalyst | layer | Catalyst- | Catalyst |
| | support | Bulk | Particle | layer | layer | Lean | layer | layer |
| | SSA | density | size | Thickness | Thickness | rate | Void ratio | Void ratio |
| | m²/g | g/ml | Nm | μm | μm | % | % | % |
| Compar- | 1200 | 0.02 | 100 | 11.2 | 2.0 | 82 | 40 | 7 |
| ative | | | | | | | | |
| Example | | | | | | | | |
| 1 | | | | | | | | |
| Example | 1200 | 0.03 | 300 | 10.0 | 6.0 | 40 | 41 | 12 |
| 1 | | | | | | | | |
| Example | 1200 | 0.04 | 300 | 11.0 | 8.0 | 27 | 33 | 19 |
| 2 | | | | | | | | |
| Compar- | 1200 | 0.07 | 500 | 10.0 | 3.0 | 70 | 25 | 12 |
| ative | | | | | | | | |
| Example | | | | | | | | |
| 2 | | | | | | | | |
| Compar- | 1000 | 0.03 | 100 | 10.5 | 2.0 | 81 | 38 | 10 |
| ative | | | | | | | | |
| Example | | | | | | | | |
| 3 | | | | | | | | |
| Example | 1000 | 0.05 | 300 | 10.2 | 6.8 | 33 | 33 | 21 |
| 3 | | | | | | | | |
| Example | 1000 | 0.07 | 400 | 10.0 | 7.5 | 25 | 35 | 28 |
| 4 | | | | | | | | |
| Compar- | 1000 | 0.08 | 500 | 10.0 | 8.3 | 17 | 37 | 13 |
| ative | | | | | | | | |
| Example | | | | | | | | |
| 4 | | | | | | | | |
| Compar- | 800 | 0.04 | 100 | 10.6 | 5.7 | 46 | 40 | 28 |
| ative | | | | | | | | |
| Example | | | | | | | | |
| 5 | | | | | | | | |
| Example | 800 | 0.04 | 300 | 10.0 | 7.0 | 30 | 35 | 17 |
| 5 | | | | | | | | |
| Example | 800 | 0.02 | 300 | 12.4 | 8.5 | 31 | 40 | 28 |
| 6 | | | | | | | | |
| Compar- | 400 | 0.02 | 50 | 8.0 | 6.0 | 25 | 38 | 20 |
| ative | | | | | | | | |
| Example | | | | | | | | |
| 6 | | | | | | | | |

TABLE 2

| | Early | After | Early | After |
|---|---|---|---|---|
| | stage | durability | stage | durability |
| | Voltage | Voltage | Gas | Gas |
| | 100% RH | 100% RH | diffusion | diffusion |
| | 2 A/cm² | 2 A/cm² | resistance | resistance |
| | V | V | s/m | s/m |
| Comparative | 662 | 211 | 23 | 252 |
| Example 1 | | | | |
| Example 1 | 551 | 502 | 31 | 52 |
| Example 2 | 521 | 470 | 30 | 51 |
| Comparative | 350 | 301 | 115 | 131 |
| Example 2 | | | | |
| Comparative | 566 | 303 | 25 | 152 |
| Example 3 | | | | |
| Example 3 | 502 | 451 | 34 | 65 |
| Example 4 | 451 | 419 | 35 | 65 |
| Comparative | 332 | 291 | 135 | 151 |
| Example 4 | | | | |
| Comparative | 470 | 352 | 32 | 97 |
| Example 5 | | | | |
| Example 5 | 421 | 399 | 42 | 49 |
| Example 6 | 599 | 401 | 41 | 51 |
| Comparative | 301 | 290 | 35 | 52 |
| Example 6 | | | | |

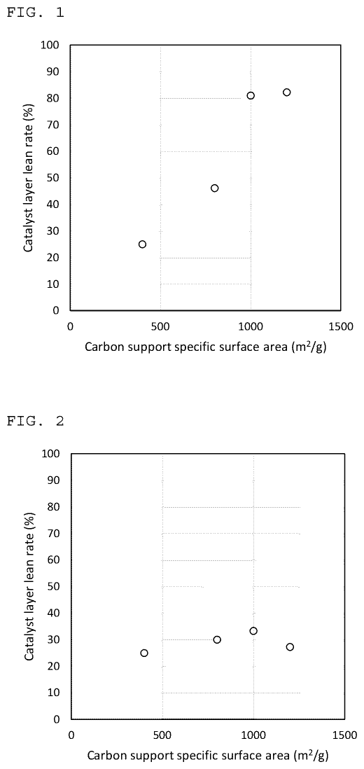

FIG. 1 shows a graph showing the relationship between the specific surface area of the carbon support particles and the lean ratio of the catalyst layer in Comparative Examples 1, 3, 5, and 6.

As shown in FIG. 1, in the carbon supports of Comparative Examples 1, 3, 5, and 6, the catalyst layer becomes thinner due to oxidation as the specific surface area increases.

FIG. 2 shows a graph showing the relationship between the specific surface area of the carbon support particles and the lean ratio of the catalyst layer in Examples 2, 3 and 5 and Comparative Example 6.

As shown in FIG. 2, in the carbon supports of Examples 2, 3, and 5, it is possible to suppress an increase in the lean rate of the catalyst layer even if the specific surface area is increased.

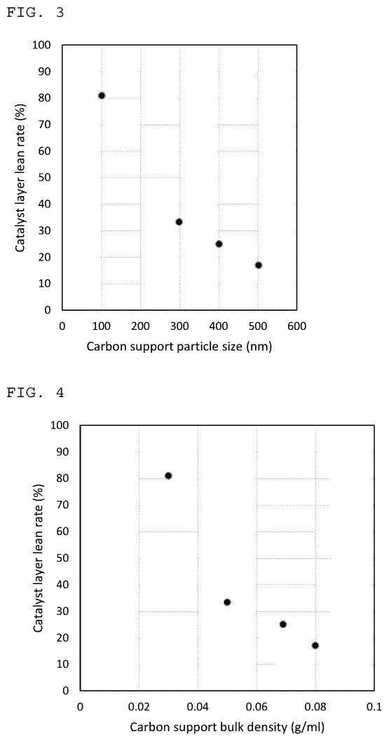

FIG. 3 shows a graph showing the relationship between the particle size of the carbon support particles and the lean ratio of the catalyst layer in Examples 3 and 4 and Comparative Examples 3 and 4.

As shown in FIG. 3, by increasing the particle size of the carbon support, an increase in the lean rate of the catalyst layer can be suppressed.

FIG. 4 shows a graph showing the relationship between the bulk density of the carbon support particles and the lean ratio of the catalyst layer in Examples 3 and 4 and Comparative Examples 3 and 4.

As shown in FIG. 4, by increasing the bulk density of the carbon support, an increase in the lean rate of the catalyst layer can be suppressed.

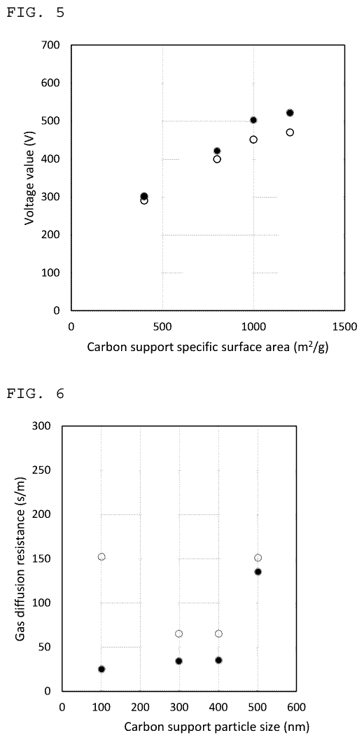

FIG. 5 shows a graph showing the relationship between the specific surface area of the carbon support particles and the voltage of the fuel cell when the power generation performance of the fuel cell before and after a durability test was evaluated in a predetermined condition in Examples 2, 3 and 5 and Comparative Example 6. Before the durability test is indicated by a black circle, and after the durability test is indicated by a white circle.

As shown in FIG. 5, in Examples 2, 3, and 5, it is possible to suppress performance deterioration of the fuel cell after the durability test even if the specific surface area of the carbon support is increased.

On the other hand, as shown in Tables 1 to 2, in Comparative Examples 1, 3, 5, and 6, when the specific surface area of the carbon support is increased, the performance of the fuel cell after the durability test is significantly deteriorated.

FIG. 6 shows a graph showing the relationship between the particle size of the carbon support particles and the gas diffusion resistance of the fuel cell before and after the durability test in Examples 3 and 4 and Comparative Examples 3 and 4. Before the durability test is indicated by a black circle, and after the durability test is indicated by a white circle.

As shown in FIG. 6, when the catalyst layer lean rate increases, the voids in the catalyst layer decrease and the gas diffusion resistance increases. As shown in Comparative Example 3, when the particle size of the carbon support is small, the initial gas diffusion resistance is low, but the gas diffusion resistance after durability is high. As shown in Comparative Example 4, when the particle size of the carbon support is large, the increase in the gas diffusion resistance after durability can be suppressed, but the gas diffusion resistance is high from the beginning.

1. A catalyst for fuel cells,
wherein the catalyst comprises a metal catalyst and a carbon support;
wherein the carbon support supports the metal catalyst;
wherein the carbon support is carbon support particles;
wherein a specific surface area of the carbon support particles is 800 m²/g or more and 1200 m²/g or less;
wherein a particle size of the carbon support particles is 200 nm or more and 400 nm or less; and
wherein a bulk density of the carbon support particles is 0.02 g/ml or more and 0.07 g/ml or less.

2. The catalyst according to claim 1,
wherein the particle size of the carbon support particles is 300 nm or more and 400 nm or less.

3. The catalyst according to claim 1,
wherein the bulk density of the carbon support particles is 0.05 g/ml or more and 0.07 g/ml or less.
